(19) United States
(12) Patent Application Publication
(10) Pub. No.: US 2026/0125941 A1
(43) Pub. Date: May 7, 2026

(54) SYSTEM AND METHOD FOR CONTROLLING CHARGING DOOR OF VEHICLE BASED ON ULTRA-WIDEBAND

(71) Applicants: Hyundai Motor Company, Seoul (KR); Kia Corporation, Seoul (KR)

(72) Inventors: Maoheng Ge, Yantai (CN); Kyu Geol Lee, Hwaseong-si (KR); Yan Xiang Huang, Yantai (CN); Ming Jie Zhang, Yantai (CN); Yuan Li, Yantai (CN); Jin Chao Zhang, Yantai (CN)

(21) Appl. No.: 19/357,746

(22) Filed: Oct. 14, 2025

(30) Foreign Application Priority Data
Nov. 5, 2024 (CN) 202411564150.5

(51) Int. Cl. E05F 15/73; B60L 53/16; B60R 16/023; G06V 20/56; G07C 5/08

(52) U.S. Cl. CPC E05F 15/73; B60L 53/16; G07C 5/0825; G07C 5/0833; B60R 16/0231; E05F 2015/767; E05Y 2400/66; E05Y 2900/534; G06V 20/56

(57) ABSTRACT

Certain examples relate to controlling a charging door of a vehicle based on an UWB. A system includes a charging door, a charging device, a vehicle-mounted UWB communication device, a vehicle-mounted camera device, a main control unit, and a charging door control device. The charging door may cover a charging port. The charging device includes a first UWB communication device. The first UWB communication device may transmit and receive a UWB communication signal. The vehicle-mounted UWB communication device may detect location information of the charging device based on the UWB communication signal. The vehicle-mounted camera device may capture image information near the charging door. The main control unit may generate a charging door control signal for opening or closing the charging door based on the location information and image information. The charging door control device may open or close the charging door based on the charging door control signal.

### CROSS-REFERENCE TO RELATED APPLICATIONS

This application claims priority to and the benefit of Chinese Patent Application No. 202411564150.5 filed at the Chinese National Intellectual Property Administration on Nov. 5, 2024, the entire contents of which are incorporated herein by reference.

### TECHNICAL FIELD

The present disclosure relates to vehicle control, and more particularly, to a system and a method for controlling a charging door of a vehicle based on an ultra-wideband (UWB).

### BACKGROUND

As vehicle control technology continues to advance, users' demands for charging convenience and intelligence are increasing.

Conventional methods of opening a vehicle charging door mainly include using a car key, using an inside button, and using an outside button. This conventional method is not convenient. In particular, in cold or rainy weather, it is not only inconvenient but may also cause inconvenience to the user since the user has to operate the vehicle charging door manually.

Further, if the indications for a charging port are unclear, the user may have difficulty charging and may even damage the vehicle due to improper operation.

Therefore, the design of the charging door of the vehicle needs to evolve in a more intelligent and humanized direction to provide a more convenient user experience.

The above information disclosed in this Background section is provided only to facilitate understanding of the background of the present disclosure, and may therefore include information that is not a part of the prior art already known to those skilled in the art to which the present disclosure pertains.

### SUMMARY

The present disclosure provides a system and method for detecting the location of a charging device and/or a user based on an ultra-wideband (UWB) communication technology, thereby allowing a user to control a charging door more intelligently.

According to an embodiment of the present disclosure, a system for controlling a charging door of a vehicle based on the ultra-wideband (UWB) may be provided. The system may include a charging door, a charging device, a vehicle-mounted UWB communication device, a vehicle-mounted camera device, a main control unit, and a charging door control device, wherein the charging door is configured to cover a charging port of the vehicle; the charging device is configured to be electrically connected to the charging port of the vehicle to charge the vehicle, the charging device includes a first UWB communication device, and the first UWB communication device is configured to transmit and receive a UWB communication signal; the vehicle-mounted UWB communication device comprises a UWB processing module and a plurality of vehicle-mounted UWB communication modules, wherein the UWB processing module and the plurality of vehicle-mounted UWB communication modules are configured to be communicatively connected to each other, the plurality of vehicle-mounted UWB communication modules is configured to perform UWB communication with the first UWB communication device of the charging device and transmit the received UWB communication signal of the charging device to the UWB processing module, and the UWB processing module detects location information of the charging device based on the received UWB communication signal of the charging device; the vehicle-mounted camera device is configured to obtain image information near the charging door of the vehicle; the main control unit is communicatively connected to the vehicle-mounted UWB communication device and the vehicle-mounted camera device, respectively, and the main control unit is configured to generate a charging door control signal for opening or closing the charging door based on the location information of the charging device and the image information near the charging door of the vehicle when the vehicle is stopped; and the charging door control device is communicatively connected to the main control unit and electrically connected to the charging door of the vehicle, and the charging door control device is configured to open or close the charging door based on the charging door control signal of the main control unit.

The system according to an embodiment of the present disclosure may further include a user-portable second UWB communication device, wherein the second UWB communication device may be configured to transmit and receive a UWB communication signal; the plurality of vehicle-mounted UWB communication modules of the vehicle-mounted UWB communication device is configured to perform UWB communication with the second UWB communication device and transmit the received UWB communication signal of the second UWB communication device to the UWB processing module of the vehicle-mounted UWB communication device, and the UWB processing module detects location information of a user based on the received UWB communication signal of the second UWB communication device; and the main control unit is further configured to generate the charging door control signal for opening or closing the charging door based on the location information of the user, the location information of the charging device, and the image information near the charging door of the vehicle.

The main control unit may be further configured to: detect whether the charging device is located within a set range of the vehicle; determine whether the distance between the charging device and the charging door of the vehicle is less than a first predetermined distance based on detecting that the charging device is located within the set range of the vehicle; determine whether the charging device has approached the charging door of the vehicle based on the image information near the charging door of the vehicle based on determining that the distance between the charging device and the charging door of the vehicle is less than the first predetermined distance; and generate the charging door control signal for opening the charging door based on determining that the charging device has approached the charging door of the vehicle.

The main control unit may be further configured to: detect whether the charging device is located within a set range of the vehicle; determine whether the distance between the user and the charging device is less than a second predetermined distance based on detecting that the charging device is located within the set range of the vehicle; determine whether the distance between the user or the charging device and the charging door of the vehicle is less than a first predetermined distance based on determining that the distance between the user and the charging device is less than the second predetermined distance; determine whether the charging device has approached the charging door of the vehicle based on the image information near the charging door of the vehicle based on determining that the distance between the user or the charging device and the charging door of the vehicle is less than the first predetermined distance; and generate the charging door control signal for opening the charging door based on determining that the charging device has approached the charging door of the vehicle.

The set range of the vehicle may be a predetermined distance range between the charging device and a front, a rear, a left, or a right side of the vehicle, the predetermined distance may be set within a range of 3 m to 6 m, the first predetermined distance may be set within a range of 0.5 m to 1.5 m, and the second predetermined distance may be set within a range of 0.5 m to 1.5 m.

The main control unit may be further configured to: identify whether different circles in an image have the same cut ratio based on the image information near the charging door of the vehicle; and determine that the charging device has approached the charging door of the vehicle based on identifying that the different circles in the image have the same cut ratio.

The main control unit may be further configured to: detect whether the charging device is electrically connected to the charging port of the vehicle within a predetermined time in response to the charging door of the vehicle being open; determine that the charging device is charging the vehicle based on detecting that the charging device is electrically connected to the charging port of the vehicle within the predetermined time; detect whether the charging device is electrically disconnected from the charging port of the vehicle when the charging device is charging the vehicle; determine whether the distance between the charging device and the charging door of the vehicle is greater than the first predetermined distance based on detecting that the charging device is disconnected from the charging port of the vehicle; and generate the charging door control signal for closing the charging door based on determining that the distance between the charging device and the charging door of the vehicle is greater than the first predetermined distance, and may be further configured to set the predetermined time within a range of 20 s to 40 s.

The main control unit may be further configured to generate the charging door control signal for closing the charging door based on detecting that the charging device is not electrically connected to the charging port of the vehicle within the predetermined time in response to the charging door of the vehicle being open.

The system according to an embodiment of the present disclosure may further include a voice output device electrically connected to the main control unit and configured to transmit a voice alarm based on a control signal from the main control unit; and an indicating device electrically connected to the main control unit and configured to light an indicating light based on the control signal from the main control unit, wherein the main control unit is further configured to generate the control signal causing the voice output device to transmit the voice alarm or the indicating device to light the indicating light based on generating the charging door control signal for opening or closing the charging door.

A communicative connection may include a connection through a wired communication method, the wired communication method may include a controller area network, a universal serial bus, a high-definition multimedia interface and a digital video interface.

The vehicle-mounted camera may be configured to obtain the image information near the charging door of the vehicle based on the location information of the charging device detected by the vehicle-mounted UWB communication device.

According to an embodiment of the present disclosure, a method for controlling a charging door of a vehicle based on an ultra-wideband (UWB) may be provided. The method may include: transmitting a UWB communication signal by a first UWB communication device of a charging device, detecting location information of the charging device based on the UWB communication signal of the charging device received by a vehicle-mounted UWB communication device, obtaining image information near the charging door of the vehicle by a vehicle-mounted camera device; generating a charging door control signal for opening or closing the charging door based on the location information of the charging device and the image information near the charging door of the vehicle by a main control unit when the vehicle is stopped; and opening or closing the charging door based on the charging door control signal of the main control unit by the charging door control device.

The method according to an embodiment of the present disclosure may further include: transmitting a UWB communication signal by a user-portable second UWB communication device, detecting location information of a user based on the UWB communication signal of the second UWB communication device received by the vehicle-mounted UWB communication device; and generating the charging door control signal for opening or closing the charging door based on the location information of the user, the location information of the charging device, and the image information near the charging door of the vehicle by the main control unit.

The method according to an embodiment of the present disclosure may further include: detecting whether the charging device is located within a set range of the vehicle; determining whether the distance between the charging device and the charging door of the vehicle is less than a first predetermined distance based on detecting that the charging device is located within the set range of the vehicle; determining whether the charging device has approached the charging door of the vehicle based on the image information near the charging door of the vehicle based on determining that the distance between the user or the charging device and the charging door of the vehicle is less than the first predetermined distance; and generating the charging door control signal for opening the charging door based on determining that the charging device has approached the charging door of the vehicle.

The method according to an embodiment of the present disclosure may further include: detecting whether the charging device is located within a set range of the vehicle; determining whether the distance between the user and the charging device is less than a second predetermined distance based on detecting that the charging device is located within the set range of the vehicle; determining whether the distance between the user or the charging device and the charging door of the vehicle is less than a first predetermined distance based on determining that the distance between the user and the charging device is less than the second predetermined distance; determining whether the charging device has approached the charging door of the vehicle based on the image information near the charging door of the vehicle based on determining that the distance between the user or the charging device and the charging door of the vehicle is less than the first predetermined distance; and generating the charging door control signal for opening the charging door based on determining that the charging device has approached the charging door of the vehicle.

The set range of the vehicle may be a predetermined distance range between the charging device and a front, a rear, a left, or a right side of the vehicle, the predetermined distance may be set within a range of 3 m to 6 m, the first predetermined distance may be set within a range of 0.5 m to 1.5 m, and the second predetermined distance may be set within a range of 0.5 m to 1.5 m.

The method according to an embodiment of the present disclosure may further include: identifying whether different circles in an image have the same cut ratio based on the image information near the charging door of the vehicle; and determining that the charging device has approached the charging door of the vehicle based on identifying that the different circles in the image have the same cut ratio.

The method according to an embodiment of the present disclosure may further include: detecting whether the charging device is electrically connected to the charging port of the vehicle within a predetermined time in response to the charging door of the vehicle being open; determining that the charging device is charging the vehicle based on detecting that the charging device is electrically connected to the charging port of the vehicle within the predetermined time; detecting whether the charging device is electrically disconnected from the charging port of the vehicle is disconnected when the charging device is charging the vehicle; determining whether the distance between the charging device and the charging door of the vehicle is greater than the first predetermined distance based on detecting that the charging device is disconnected from the charging port of the vehicle; and generating the charging door control signal for closing the charging door based on determining that the distance between the charging device and the charging door of the vehicle is greater than the first predetermined distance, wherein the predetermined time may be set within a range of 20 s to 40 s.

The method according to an embodiment of the present disclosure may further include generating the charging door control signal for closing the charging door based on detecting that the charging device is not electrically connected to the charging port of the vehicle within the predetermined time in response to the charging door of the vehicle being open.

The method according to an embodiment of the present disclosure may further include generating a control signal causing a voice output device to transmit a voice alarm or an indicating device to light an indicating light by the main control unit based on generating that the charging door control signal for opening or closing the charging door.

The present disclosure adopts the above technical solution and has the following beneficial effects:
1. Automatic operation: Using the ultra-wideband (UWB) communication technology, the charging door may open automatically when the charging device or user approaches the vehicle. This automatic operation, which does not require manual intervention, improves the convenience of operation and eliminates the need for the user to manually open and close the door, especially in bad weather (rain, snow, or extreme cold, etc.).
2. Auxiliary guidance system: Installing indicating lights or speakers near the charging port may provide visual and auditory guidance to users, ensuring the accuracy and stability of the charging connection. This guidance changes according to different charging states, such as color changes or voice notifications, to help users easily check and complete the charging process.
3. Enhanced user experience: Integrating intelligent technologies, simplifying the charging process, and improving overall satisfaction with the vehicle.
4. Stability and reliability: The introduction of UWB technology adds an anti-theft feature as the opening of the charging door may only be triggered by an authenticated device.
5. Adaptability and compatibility: Supporting various charging initiation methods including existing car keys, mobile phone applications, or other smart devices, adapting to different users' habits and technology needs.

In summary, the present disclosure not only improves the convenience and efficiency of vehicle charging by combining UWB wireless communication technology and humanized design, but also improves the safety and user-friendliness of the entire charging process.

In addition, any advantages which may be acquired or inferred from the embodiments of the present disclosure are directly or implicitly disclosed in the detailed description of the embodiment of the present disclosure. That is, various advantages inferred from the embodiments of the present disclosure are disclosed in the detailed description that follows.

### BRIEF DESCRIPTION OF THE DRAWINGS

Hereinafter, an embodiment of the present disclosure is described in more detail with reference to the accompanying drawings. For clarity of description, identical parts in different drawings are indicated using the same reference numerals. It should be noted that the drawings are illustrative only and are not necessarily drawn to scale.

FIG. 1 is a block diagram illustrating a system for controlling a charging door of a vehicle according to an embodiment of the present disclosure.

FIG. 2 is a flowchart illustrating a method for controlling the charging door of the vehicle according to an embodiment of the present disclosure.

FIG. 3 is a flowchart illustrating a method for controlling the charging door of the vehicle based on a UWB according to an embodiment of the present disclosure.

FIG. 4 is a flowchart illustrating the method for controlling the charging door of the vehicle based on the UWB according to another embodiment of the present disclosure.

### DETAILED DESCRIPTION OF ILLUSTRATIVE EMBODIMENTS

Hereinafter, embodiments of the present disclosure will be described in detail. The present embodiments are implemented based on the technical solution of the present disclosure, and detailed implementation methods and specific operation processes are presented. However, the scope of the present disclosure is not limited to the following embodiments.

Hereinafter, embodiments of the present disclosure will be described in detail with reference to the attached drawings.

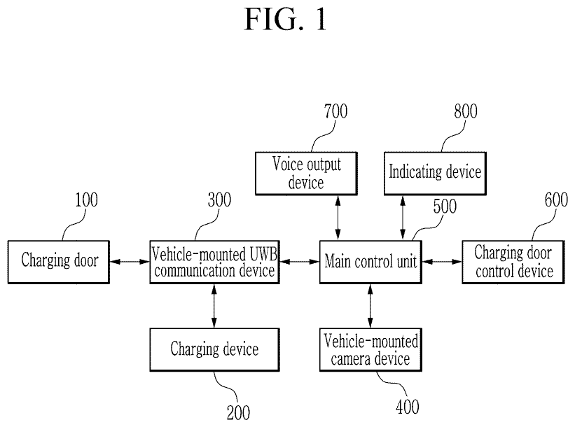

FIG. 1 is a block diagram illustrating a system for controlling a charging door of a vehicle based on an ultra-wideband UWB according to an embodiment of the present disclosure. The system for controlling the charging door of the vehicle based on the UWB according to an embodiment of the present disclosure may include a charging door 100, a charging device 200, a vehicle-mounted UWB communication device 300, a vehicle-mounted camera device 400, a main control unit 500, and a charging door control device 600.

The charging door 100 may cover a charging port (not shown) of the vehicle. The main function of the charging door 100 is to protect the charging port from environmental factors (e.g., rain and dust), prevent damage and corrosion, and extend the service life of the charging port.

The charging device 200 may be electrically connected to the charging port of the vehicle and configured to charge the vehicle. The charging device 200 may include a UWB communication device, and the UWB communication device may transmit and receive a UWB communication signal.

According to an embodiment of the present disclosure, the charging device 200 is a general term encompassing various charging devices, which may specifically include an alternating current (AC) charging gun and/or a direct current (DC) charging gun, and is suitable for low-speed charging at home or in commercial locations, fast charging for long-distance travel or emergency charging, etc. Additionally, the charging device 200 may further include a robot arm equipped with a charging gun for automatically charging the electric vehicle. The robot arm may automatically position itself in the charging port of the vehicle and connect to the charging gun, providing a convenient charging service to a user.

Additionally, the system for controlling the charging door of the vehicle based on the UWB according to an embodiment of the present disclosure may be used by the user, and the user may be a driver or another person riding in the vehicle. The user may carry the UWB communication device, and the UWB communication device may transmit and receive the UWB communication signal. The UWB communication device may include a car key and/or a mobile device. The mobile device may include any portable mobile device such as a mobile phone, tablet, etc.

Ultra-wideband (UWB) technology is a wireless communication technology that transmits data using narrow pulses in the nanosecond range. UWB technology may achieve centimeter-level, even millimeter-level position tracking accuracy, which is very advantageous for capturing detailed movement trajectories and height changes. Since the UWB signals have a very narrow time width, the receiver may achieve very high time resolution during measurements, ensuring position tracking accuracy. UWB technology supports not only two-dimensional planar position tracking, but also three-dimensional spatial position tracking. This allows for the detection of movement of the charging device and/or the user in three-dimensional space, including vertical movement, thereby enabling the perfect recording of movement trajectories. UWB position tracking technology has become an ideal choice for detecting the movement trajectories of the charging device and/or the user due to its high-precision, multi-dimensional spatial position tracking capability, and applicability in complex environments.

The vehicle-mounted UWB communication device 300 may include a UWB processing module and a plurality of vehicle-mounted UWB communication modules, and the UWB processing module may be connected to enable communication with each of the plurality of vehicle-mounted UWB communication modules via a wired communication method. The plurality of vehicle-mounted UWB communication modules are configured to perform UWB communication with the charging device 200 and/or the UWB communication device of the user, and transmit the received charging device 200 and/or the UWB communication signal of the user to the UWB processing module. The UWB processing module detects location information of the charging device 200 and/or the user based on the received charging device 200 and/or the UWB communication signal of the user, and converts the detected location information of the charging device 200 and/or the user into a vehicle-mounted communication signal.

According to an embodiment of the present disclosure, the wired communication method may include a controller area network (CAN), a universal serial bus (USB), a high-definition multimedia interface (HDMI), a digital visual interface (DVI), and the like. A CAN communication method may include a powertrain CAN (P_CAN), a vehicle body control device CAN (B_CAN), a chassis control CAN (C_CAN), etc. However, embodiments of the present disclosure are not limited to the above communication method.

The number of vehicle-mounted UWB communication modules may be three, four, five, six or more. According to an embodiment of the present disclosure, the plurality of vehicle-mounted UWB communication modules may be five, and include a sub-vehicle-mounted UWB communication module provided at a left front corner of the vehicle, a sub-vehicle-mounted UWB communication module provided at a right front corner of the vehicle, a sub-vehicle-mounted UWB communication module provided at a left rear corner of the vehicle, a sub-vehicle-mounted UWB communication module provided at a right rear corner of the vehicle, and a main vehicle-mounted UWB communication module provided at a front ceiling position of the vehicle. However, the arrangement of the plurality of vehicle-mounted UWB communication modules is not limited thereto, and may be arranged according to the vehicle structure and actual needs.

The plurality of vehicle-mounted UWB communication modules may be connected to enable communication to each other via a wired communication method, and at least one of the plurality of vehicle-mounted UWB communication modules may be connected to the main control unit 500. According to an embodiment of the present disclosure, among the plurality of vehicle-mounted UWB communication modules, only the main vehicle-mounted UWB communication module may be directly connected to the main control unit 500, and other sub-vehicle-mounted UWB communication modules may be connected to enable communication with the main vehicle-mounted UWB communication module.

Additionally, one or more of the plurality of vehicle-mounted UWB communication modules may perform communication authentication with the charging device 200 and/or the UWB communication device of the user. According to an embodiment of the present disclosure, only the main vehicle-mounted UWB communication module may perform communication authentication with the charging device 200 and/or the UWB communication device of the user, and other sub-vehicle-mounted UWB communication modules may be configured to detect location information of the charging device 200 and/or the UWB communication device of the user.

The vehicle-mounted camera device 400 may be configured to capture image information near the charging door of the vehicle. According to an embodiment of the present disclosure, the vehicle-mounted camera device 400 may be a camera mounted on a car, including a front camera, a rear camera, a left camera, a right camera, etc. These cameras may operate alone or in concert to provide assistance as the vehicle approaches the charging device.

The main control unit 500 may be connected to enable communication with each of the vehicle-mounted UWB communication device 300 and the vehicle-mounted camera device 400 in a wired communication method, and when the vehicle is stopped, may be configured to generate a charging door control signal for opening or closing the charging door based on the location information of the user and/or the location information of the charging device and image information near the charging door of the vehicle. According to an embodiment of the present disclosure, the main control unit 500 may be a body domain controller (BDC).

According to an embodiment of the present disclosure, the vehicle is stopped may refer to a state in which the vehicle is no longer moving and a charging operation is possible, and this may include various situations. In the case of a conventional internal combustion engine vehicle, a stopped state of the vehicle means that the engine of the vehicle has already been turned off and the ignition system has stopped operating. In the case of an electric vehicle, a stopped state of the vehicle means that the electric vehicle has stopped and is being supplied with electric power.

Specifically, the main control unit 500 is configured to detect whether the location of the charging device 200 is within the set range of the vehicle, determine whether the distance between the charging device 200 and the charging door 100 of the vehicle is less than a first predetermined distance when the location of the charging device 200 is detected to be within the set range of the vehicle 200, determine whether the charging device 200 has approached the charging door 100 of the vehicle based on image information near the charging door 100 of the vehicle when the distance between the charging device 200 and the charging door 100 of the vehicle is determined to be less than the first predetermined distance, and generate the charging door control signal for opening the charging door 100 when the charging device 200 is determined to have approached the charging door 100 of the vehicle.

According to an embodiment of the present disclosure, the set range of the vehicle may be a predetermined distance range between the charging device 200 and the front, rear, left, or right side of the vehicle. The predetermined distance range may be set within a range of 3 m to 6 m, for example, 5 m. The set range of the vehicle is exemplary only, and the embodiments of the present disclosure are not limited thereto. The first predetermined distance may be set within a range of 0.5 m to 1.5 m—for example, 1 m. The range of the first predetermined distance is merely exemplary, and the embodiments of the present disclosure are not limited thereto.

According to an embodiment of the present disclosure, determining whether the charging device 200 has approached the charging door of the vehicle based on image information near the charging door 100 of the vehicle may include capturing an image near the charging door 100 of the vehicle by the vehicle-mounted camera device 400, performing processing including filtering, contrast enhancement, or other preprocessing steps by the main control unit 500 to facilitate feature extraction, and identifying specific features in the image processed by the main control unit 500, which may be specific marks, shapes, or any other visual cues that may be used for detection of the charging device.

In particular, the main control unit 500 may identify various circular structures in the image and analyze whether the cut ratio is the same. If the cut ratios of all circles are the same, it indicates that the circles are located in similar positional relationships and distances. If the cut ratios of the various circles in the image are identified as being the same, the main control unit 500 determines that the charging device 200 has approached the charging door 100 of the vehicle.

The method described above is one embodiment of detecting whether the charging device 200 has approached the charging door 100 of the vehicle using image identification technology. However, since the geometric shapes or marks of different charging devices 200 are different, different image identification techniques and algorithms may be used. Therefore, the embodiment of the present disclosure is not limited to the above method, and may encompass any other image analysis technology capable of accurately determining the corresponding location of any charging device and the charging door 100.

The embodiment of the present disclosure ensures safe operation while considering convenience in actual use by the user. This distance detection and image identification may ensure that the charging process is only activated when the charging device is definitely ready to charge the vehicle and is in a safe position, thus reducing the risk of misoperation.

When the charging door 100 of the vehicle is open, if the charging device 200 and the charging port of the vehicle are electrically connected within a predetermined time, the main control unit 500 may determine that the charging device 200 is charging the vehicle. When the charging device 200 is charging the vehicle, the main control unit 500 may detect whether the electrical connection between the charging device 200 and the charging port of the vehicle is disconnected, determine whether the distance between the charging device 200 and the charging door 100 of the vehicle is greater than the first predetermined distance (which may be set within a range of 0.5 m to 1.5 m, and is 1 m in one example) when it is detected that the electrical connection between the charging device 200 and the charging port of the vehicle is disconnected, and generate the charging door control signal for closing the charging door 100 when the distance between the charging device 200 and the charging door 100 of the vehicle is determined to be greater than the first predetermined distance.

The predetermined time may be set within a range of 20 s to 40 s—for example, 30 s. The above predetermined time range is only exemplary, and the embodiments of the present disclosure are not limited thereto.

When the charging door 100 of the vehicle is open, the main control unit 500 may generate the charging door control signal for closing the charging door 100 when the charging device 200 and the charging port of the vehicle are not electrically connected within the predetermined time.

Alternatively, the main control unit 500 detects whether the location of the charging device 200 is within the set range of the vehicle, and determines whether the distance between the user 200 and the charging device 200 is less than a second predetermined distance when the location of the charging device 200 is detected to be within the set range of the vehicle. If the distance between the user and the charging device 200 is determined to be less than the second predetermined distance (which means that the user has approached the charging device 200 after getting off), the main control unit 500 determines whether the distance between the user or the charging device 200 and the charging door 100 of the vehicle is less than the first predetermined distance, and if the distance between the user or the charging device 200 and the charging door 100 of the vehicle is determined to be less than the first predetermined distance, the main control unit 500 determines whether the charging device 200 has approached the charging door 100 of the vehicle based on image information near the charging door 100 of the vehicle. The main control unit 500 may be configured to generate the charging door control signal for opening the charging door 100 when the charging device 200 is determined to have approached the charging door 100 of the vehicle.

The second predetermined distance may be set within a range of 0.5 m to 1.5 m—for example, 1 m. The range of the second predetermined distance is merely exemplary, and the embodiments of the present disclosure are not limited thereto.

The charging door control device 600 is connected to enable communication with the main control unit 500 and may be electrically connected to the charging door 100 of the vehicle. The charging door control device 600 may be configured to open or close the charging door based on the charging door control signal of the main control unit 500. According to an embodiment of the present disclosure, the charging door control device 600 may include a processing unit and a driving motor, and the processing unit is electrically connected to the driving motor. The driving motor must be connected to the processing unit, which is responsible for receiving and processing signals and executing corresponding control instructions. The driving motor is for driving the opening and closing of the charging door.

The system for controlling the charging door of the vehicle based on the UWB according to an embodiment of the present disclosure may further include a voice output device 700 and an indicating device 800. The voice output device 700 and the indicating device 800 are each mounted near the charging port of the vehicle and may be electrically connected to the main control unit 500. The voice output device 700 may be configured to transmit a voice alarm based on a control signal from the main control unit 500 and may be a speaker or other type of audio output device, the purpose of which is to provide auditory feedback to inform the user of a change in the status of the charging door 100 or to alert the user to a potential problem that may exist. The indicating device 800 may be configured to light an indicating light based on a control signal from the main control unit 500, and may be an LED lamp or other type of visual output device, the purpose of which is to provide visual feedback to inform the user of the location of the charging port and the status of the charging door (e.g., charging in progress, charging complete, failure, etc.).

The main control unit 500 may additionally be configured to allow the voice output device 700 to transmit a voice alarm and/or allow the indicating device 800 to generate a control signal to light an indicating light when a charging control signal for opening or closing the charging door 100 is generated.

Therefore, the system for controlling the charging door of the vehicle based on the UWB according to an embodiment of the present disclosure automatically opens the charging door 100 when the charging device 200 and/or the user has approached the charging door 100 of the vehicle by using UWB communication technology. This automatic operation, which requires no manual intervention, improves the convenience of operation. Additionally, by installing an indicating light and/or speaker near the charging port, visual and audible guidance is provided to the user, ensuring the accuracy and safety of the charging connection. In summary, the system for controlling the charging door of the vehicle based on the UWB according to an embodiment of the present disclosure significantly improves user convenience and safety during vehicle charging through automatic operation and multi-sensory guidance.

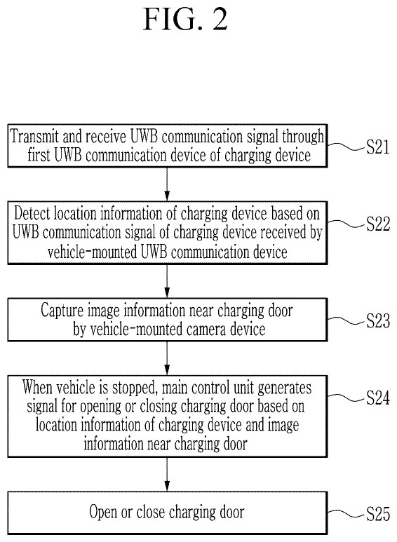

FIG. 2 is a flowchart illustrating a method for controlling the charging door of the vehicle according to an embodiment of the present disclosure. Referring to FIG. 2, in step (S21), the UWB communication signal is transmitted and received by a first UWB communication device of the charging device 200; in step (S22), location information of the charging device 200 is detected based on the UWB communication signal of the charging device 200 received by the vehicle-mounted UWB communication device 300; in step (S23), image information near the charging door 100 of the vehicle is captured by a vehicle-mounted camera device 400; and in step (S24), when the vehicle has stopped, the charging door control signal for opening or closing the charging door 100 is generated by the main control unit 500 based on the location information of the charging device 200 and the image information near the charging door 100 of the vehicle; and in step (S25), the charging door 100 may be open or closed based on the charging door control signal of the main control unit 500 by the charging door control device 600.

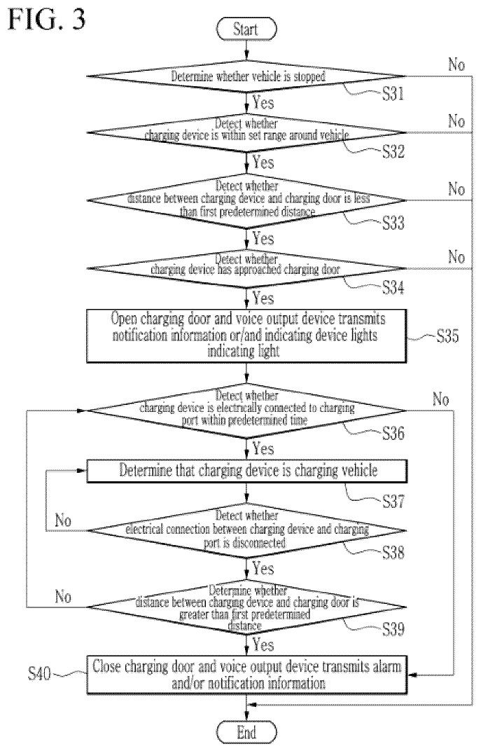

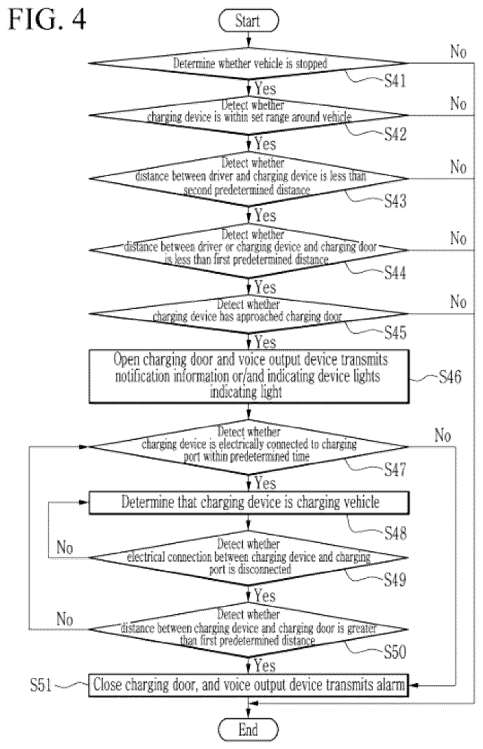

Referring to FIGS. 3 and 4 below, the operational flow of a method for controlling the charging door of the vehicle based on the UWB according to an embodiment of the present disclosure will be described through detailed examples.

FIG. 3 is a flowchart illustrating the method for controlling the charging door of the vehicle based on the UWB according to an embodiment of the present disclosure in a charging scene below, where the user has stopped the vehicle in a charging area and then charged the vehicle by a robot arm equipped with the charging device.

In step (S31), it is determined whether the vehicle has been stopped by the main control unit 500. When it is determined that the vehicle has been stopped (i.e., “Yes” in (step S31)), in step (S32), the main control unit 500 detects whether the charging device 200 is located within a set range around the vehicle based on the location information of the charging device 200. Here, the main control unit 500 may obtain location information of the charging device 200 by the vehicle-mounted UWB communication device 300, and compare the location information of the charging device 200 with a set range around the vehicle to determine whether the charging device 200 is located within the range.

When the charging device 200 is detected to be located within the set range of the vehicle (i.e., “Yes” in step (S32)), in step (S33), the main control unit 500 determines whether the distance between the charging device 200 and the charging door 100 of the vehicle is less than the first predetermined distance.

When the distance between the user or the charging device 200 and the charging door 100 of the vehicle is determined to be less than the first predetermined distance (i.e., “Yes” in step (S33), which indicates that the robot arm equipped with the charging device 200 has approached the charging door 100 of the vehicle), in step (S34), the main control unit 500 determines whether the charging device 200 has approached the charging door 100 of the vehicle based on image information near the charging door 100 of the vehicle.

When it is determined that the charging device 200 has approached the charging door 100 of the vehicle (i.e., “Yes” in step (S34)), it is further determined that the robot arm equipped with the charging device 200 has approached the charging door 100 of the vehicle, in step (S35), the charging door control signal for opening the charging door 100 is generated by the main control unit 500, thereby opening the charging door 100 and allowing the voice output device 700 to transmit notification information, or the indicating device 800 to turn on the indicating light.

When the charging door 100 of the vehicle is open, in step (S36), the main control unit 500 detects whether the charging device 200 is electrically connected to the charging port of the vehicle within a predetermined time (e.g., 30s).

When the charging device 200 and the charging port of the vehicle are electrically connected within a predetermined time, in step (S37), the main control unit 500 determines that the charging device 200 is charging the vehicle. When the charging device 200 and the charging port of the vehicle are not electrically connected within a predetermined time (i.e., “No” in step (S36)), in step (S40), the main control unit 500 generates the charging door control signal to close the charging door 100, thereby closing the charging door 100 and allowing the voice output device 700 to transmit an alarm.

When the charging device 200 is charging the vehicle (i.e., the charging door 100 remains open), in step (S38), it is detected whether the electrical connection between the charging device 200 and the charging port of the vehicle is disconnected.

When it is detected that the electrical connection between the charging device 200 and the charging port of the vehicle is disconnected (i.e., “Yes” in step (S38)), in step (S39), it is determined whether the distance between the charging device 200 and the charging door 100 of the vehicle is greater than the first predetermined distance.

When the distance between the charging device 200 and the charging door 100 of the vehicle is determined to be greater than the first predetermined distance (i.e., “Yes” in step (S39)), in step (S40), the charging door control signal for closing the charging door 100 is generated to close the charging door, and the voice output device 700 transmits alarm and/or notification information.

When it is determined that the distance between the charging device 200 and the charging door 100 of the vehicle is not greater than the first predetermined distance (i.e., “No” in step (S39)), the process returns to step (S36).

According to an embodiment of the present disclosure, when a vehicle needs to be charged, when a driver stops the vehicle in a charging area and the robot arm equipped with the charging device 200 automatically approaches the vehicle to charge the vehicle, by using the UWB communication technology, the charging door 100 may be automatically opened when the robot arm approaches the vehicle, and the charging door 100 may be automatically closed after detecting completion of charging. Therefore, it is possible to improve the convenience of operation as manual intervention by the user is not required. Additionally, visual and audible guidance may be provided to the driver through indicating lights and/or speakers mounted near the charging port, thereby ensuring the accuracy and safety of the charging connection.

FIG. 4 is a flowchart illustrating the method for controlling the charging door of the vehicle based on the UWB according to an embodiment of the present disclosure in a charging scene below, where a driver stops the vehicle in a charging area, the driver gets out carrying a car key and/or other mobile devices, and brings a charging device to charge the vehicle.

In step (S41), it is determined whether the vehicle has stopped by the main control unit 500. When it is determined that the vehicle has stopped (i.e., “Yes” in step (S41)), in step (S42), the main control unit 500 detects whether the charging device 200 is located within a set range around the vehicle based on the location information of the charging device 200.

When the charging device 200 is detected to be located within the set range of the vehicle (i.e., “Yes” in step (S42)), in step (S43), the main control unit 500 determines whether the distance between the driver and the charging device 200 is less than the second predetermined distance based on the location information of the driver and the location information of the charging device 200.

If the distance between the driver and the charging device 200 is determined to be less than the second predetermined distance (i.e., “Yes” in step (S43), which means that the driver has gotten out and approached the charging device 200), in step (S44), the main control unit 500 determines whether the distance between the driver or the charging device 200 and the charging door 100 of the vehicle is less than the first predetermined distance.

If the distance between the driver or the charging device 200 and the charging door 100 of the vehicle is determined to be less than the first predetermined distance (i.e., “Yes” in step (S44), which means that the driver has approached the charging door 100 of the vehicle while holding the charging device 200 in the driver's hand, and here, it is sufficient that the distance between at least one of the driver and the charging device 200 and the charging door 100 of the vehicle is determined to be less than the first predetermined distance), in step (S45), the main control unit 500 determines whether the charging device 200 has approached the charging door 100 of the vehicle based on image information near the charging door 100 of the vehicle.

When it is determined that the charging device 200 approached the charging door 100 of the vehicle (i.e., “Yes” in step (S45), it is further determined that that the driver has approached the charging door 100 of the vehicle while holding the charging device 200 in the driver's hand), in step (S46), the charging door control signal for opening the charging door 100 is generated by the main control unit 500, thereby opening the charging door 100 and allowing the voice output device 700 to transmit a voice alarm and/or the indicating device 800 to turn on the indicating light.

When the charging door 100 of the vehicle is open, in step (S47), the main control unit 500 detects whether the charging device 200 is electrically connected to the charging port of the vehicle within a predetermined time (e.g., 30s).

When the charging device 200 and the charging port of the vehicle are electrically connected within a predetermined time (“Yes” in step (S47)), in step (S48), the main control unit 500 determines that the charging device 200 is charging the vehicle. When the charging device 200 and the charging port of the vehicle are not electrically connected within a predetermined time (i.e., “No” in step (S47)), in step (S51), the main control unit 500 generates the charging door control signal to close the charging door 100, thereby closing the charging door 100 and allowing the voice output device 700 to transmit an alarm.

When the charging device 200 is charging the vehicle (i.e., the charging door 100 remains open), in step (S49), it is detected whether the electrical connection between the charging device 200 and the charging port of the vehicle is disconnected.

When it is detected that the electrical connection between the charging device 200 and the charging port of the vehicle is disconnected (i.e., “Yes” in step (S49)), in step (S50), it is determined whether the distance between the charging device 200 and the charging door 100 of the vehicle is greater than the first predetermined distance.

When the distance between the charging device 200 and the charging door 100 of the vehicle is determined to be greater than the first predetermined distance (i.e., “Yes” in step (S50)), in step (S51), the charging door control signal for closing the charging door 100 is generated, thereby closing the charging door 100 and allowing the voice output device 700 to transmit an alarm and/or notification information.

When it is determined that the distance between the charging device 200 and the charging door 100 of the vehicle is not greater than the first predetermined distance (i.e., “No” in step (S50)), the process returns to step (S47).

According to an embodiment of the present disclosure, when a vehicle needs to be charged, in a scene where the driver stops the vehicle in a charging area, gets out, brings the charging device, and charges the vehicle, by using the UWB communication technology, the charging door may be automatically opened when the charging device or the driver approaches the vehicle, and the charging door may be automatically closed after detecting the completion of charging. Therefore, it is possible to improve the convenience of operation as manual intervention by the driver is not required. Additionally, visual and audible guidance may be provided to the driver through indicating lights and/or speakers mounted near the charging port, thereby ensuring the accuracy and safety of the charging connection.

The various embodiments of the present disclosure do not enumerate all possible combinations, but rather describe representative aspects of the present disclosure, and furthermore, the contents described in the various embodiments may be applied independently or in a combination of two or more.

While the embodiments of the present disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. A system for controlling a charging door of a vehicle based on an ultra-wideband (UWB), the system comprising:
the charging door configured to cover a charging port of the vehicle;
a vehicle-mounted UWB communication device comprising:
a UWB processing module; and
a plurality of vehicle-mounted UWB communication modules,
wherein:
the UWB processing module and the plurality of vehicle-mounted UWB communication modules are configured to be communicatively connected to each other via a first communicative connection,
the plurality of vehicle-mounted UWB communication modules is configured to:
perform UWB communication with a first UWB communication device of a charging device; and
transmit a received UWB communication signal of the charging device to the UWB processing module, and
the UWB processing module detects location information of the charging device based on the received UWB communication signal of the charging device;
a vehicle-mounted camera device configured to obtain image information near the charging door of the vehicle;
a main control unit communicatively connected via a second communicative connection to the vehicle-mounted UWB communication device and the vehicle-mounted camera device, respectively, and configured to:
generate a charging door control signal for opening or closing the charging door based on the location information of the charging device and the image information near the charging door of the vehicle when the vehicle is stopped; and
a charging door control device communicatively connected via a third communicative connection to the main control unit and electrically connected to the charging door of the vehicle, and configured to:
open or close the charging door based on the charging door control signal of the main control unit.

2. The system of claim 1, wherein the plurality of vehicle-mounted UWB communication modules of the vehicle-mounted UWB communication device is further configured to:
perform UWB communication with a user-portable second UWB communication device; and
transmit the received UWB communication signal of the user-portable second UWB communication device to the UWB processing module of the vehicle-mounted UWB communication device,
the UWB processing module detects second location information of a user based on the received UWB communication signal of the user-portable second UWB communication device; and
the main control unit is further configured to generate the charging door control signal for opening or closing the charging door based on the second location information of the user, the location information of the charging device, and the image information near the charging door of the vehicle.

3. The system of claim 1, wherein the main control unit is further configured to:
detect whether the charging device is located within a set range of the vehicle;
determine whether a distance between the charging device and the charging door of the vehicle is less than a first predetermined distance based on detecting that the charging device is located within the set range of the vehicle;
determine whether the charging device has approached the charging door of the vehicle based on the image information near the charging door of the vehicle based on determining that the distance between the charging device and the charging door of the vehicle is less than the first predetermined distance; and
generate the charging door control signal for opening the charging door based on determining that the charging device has approached the charging door of the vehicle.

4. The system of claim 2, wherein the main control unit is further configured to:
detect whether the charging device is located within a set range of the vehicle;
determine whether a first distance between the user and the charging device is less than a second predetermined distance based on detecting that the charging device is located within the set range of the vehicle;
determine whether a second distance between the user or the charging device and the charging door of the vehicle is less than a first predetermined distance based on determining that the first distance between the user and the charging device is less than the second predetermined distance;
determine whether the charging device has approached the charging door of the vehicle based on the image information near the charging door of the vehicle based on determining that the second distance between the user or the charging device and the charging door of the vehicle is less than the first predetermined distance; and
generate the charging door control signal for opening the charging door based on determining that the charging device has approached the charging door of the vehicle.

5. The system of claim 3, wherein the set range of the vehicle is a predetermined distance range between the charging device and a front side, a rear side, a left side, or a right side of the vehicle.

6. The system of claim 3, wherein the main control unit is further configured to:
identify whether different circles in an image have a same cut ratio based on the image information near the charging door of the vehicle; and
determine that the charging device has approached the charging door of the vehicle based on identifying that the different circles in the image have the same cut ratio.

7. The system of claim 3, wherein the main control unit is further configured to:
detect whether the charging device is electrically connected to the charging port of the vehicle within a predetermined time in response to the charging door of the vehicle being open;
determine that the charging device is charging the vehicle based on detecting that the charging device is electrically connected to the charging port of the vehicle within the predetermined time;
detect whether the charging device is electrically disconnected from the charging port of the vehicle when the charging device is charging the vehicle;
determine whether the distance between the charging device and the charging door of the vehicle is greater than the first predetermined distance based on detecting that the charging device is disconnected from the charging port of the vehicle; and
generate the charging door control signal for closing the charging door based on determining that the distance between the charging device and the charging door of the vehicle is greater than the first predetermined distance.

8. The system of claim 7, wherein the main control unit is further configured to generate the charging door control signal for closing the charging door based on detecting that the charging device is not electrically connected to the charging port of the vehicle within the predetermined time in response to the charging door of the vehicle being open.

9. The system claim 1, further comprising:
a voice output device electrically connected to the main control unit and configured to transmit a voice alarm based on a control signal from the main control unit; and
an indicating device electrically connected to the main control unit and configured to light an indicating light based on the control signal from the main control unit,
wherein the main control unit is further configured to generate the control signal causing the voice output device to transmit the voice alarm or the indicating device to light the indicating light based on generating the charging door control signal for opening or closing the charging door.

10. The system of claim 1, wherein:
the first communicative connection, the second communicative connection, and the third communicative connection each respectively comprise a connection through a wired communication method, and
the wired communication method comprises a controller area network, a universal serial bus, a high-definition multimedia interface, and a digital visual interface.

11. The system of claim 1, wherein the vehicle-mounted camera device is configured to obtain the image information near the charging door of the vehicle based on the location information of the charging device detected by the vehicle-mounted UWB communication device.

12. A method for controlling a charging door of a vehicle based on an ultra-wideband (UWB), the method comprising:
receiving, by a vehicle-mounted UWB communication device, a UWB communication signal from a first UWB communication device of a charging device;
detecting location information of the charging device based on the UWB communication signal of the charging device received by the vehicle-mounted UWB communication device;
obtaining image information near the charging door of the vehicle by a vehicle-mounted camera device;
generating a charging door control signal for opening or closing the charging door based on the location information of the charging device and the image information near the charging door of the vehicle by a main control unit when the vehicle is stopped; and
opening or closing the charging door based on the charging door control signal of the main control unit by a charging door control device.

13. The method of claim 12, further comprising:
receiving, by the vehicle-mounted UWB communication device, a second UWB communication signal from a user-portable second UWB communication device;
detecting location information of a user based on the second UWB communication signal of the user-portable second UWB communication device received by the vehicle-mounted UWB communication device; and
generating the charging door control signal for opening or closing the charging door based on the location information of the user, the location information of the charging device, and the image information near the charging door of the vehicle by the main control unit.

14. The method of claim 12, further comprising:
detecting whether the charging device is located within a set range of the vehicle;
determining whether a distance between the charging device and the charging door of the vehicle is less than a first predetermined distance based on detecting that the charging device is located within the set range of the vehicle;
determining whether the charging device has approached the charging door of the vehicle based on the image information near the charging door of the vehicle based on determining that the distance between a user or the charging device and the charging door of the vehicle is less than the first predetermined distance; and
generating the charging door control signal for opening the charging door based on determining that the charging device has approached the charging door of the vehicle.

15. The method for controlling the charging door of the vehicle based on the UWB of claim 13, further comprising:
detecting whether the charging device is located within a set range of the vehicle;
determining whether a first distance between the user and the charging device is less than a second predetermined distance based on detecting that the charging device is located within the set range of the vehicle;
determining whether a second distance between the user or the charging device and the charging door of the vehicle is less than a first predetermined distance based on determining that the first distance between the user and the charging device is less than the second predetermined distance;
determining whether the charging device has approached the charging door of the vehicle based on the image information near the charging door of the vehicle based on determining that the second distance between the user or the charging device and the charging door of the vehicle is less than the first predetermined distance; and
generating the charging door control signal for opening the charging door based on determining that the charging device has approached the charging door of the vehicle.

16. The method of claim 14, wherein the set range of the vehicle is a predetermined distance range between the charging device and a front side, a rear side, a left side, or a right side of the vehicle.

17. The method of claim 14, further comprising:
identifying whether different circles in an image have a same cut ratio based on the image information near the charging door of the vehicle; and
determining that the charging device has approached the charging door of the vehicle based on identifying that the different circles in the image have the same cut ratio.

18. The method of claim 14, further comprising:
detecting whether the charging device is electrically connected to a charging port of the vehicle within a predetermined time in response to the charging door of the vehicle being open;
determining that the charging device is charging the vehicle based on detecting that the charging device is electrically connected to the charging port of the vehicle within the predetermined time;
detecting whether the charging device is electrically disconnected from the charging port of the vehicle is disconnected when the charging device is charging the vehicle;
determining whether the distance between the charging device and the charging door of the vehicle is greater than the first predetermined distance based on detecting that the charging device is disconnected from the charging port of the vehicle; and
generating the charging door control signal for closing the charging door based on determining that the distance between the charging device and the charging door of the vehicle is greater than the first predetermined distance.

19. The method of claim 18, further comprising:
generating the charging door control signal for closing the charging door based on detecting that the charging device is not electrically connected to the charging port of the vehicle within the predetermined time in response to the charging door of the vehicle being open.

20. The method of claim 12, further comprising:
generating a control signal causing a voice output device to transmit a voice alarm or an indicating device to light an indicating light by the main control unit based on generating the charging door control signal for opening or closing the charging door.
